(19) United States
(12) Patent Application Publication
(10) Pub. No.: US 2014/0312017 A1
(43) Pub. Date: Oct. 23, 2014

(54) Method For Applying a Data Marking to the Surface of a Diamond or Brilliant and For Determining the Authenticity Thereof

(71) Applicants: Alexander Potemkin, Barsbuettel (DE); Petr Nikolaevich Luskinovich, Moscow (RU); Vladimir Alexandrovich Zhabotinsky, Moscow (RU)

(72) Inventors: Alexander Potemkin, Barsbuettel (DE); Petr Nikolaevich Luskinovich, Moscow (RU); Vladimir Alexandrovich Zhabotinsky, Moscow (RU)

(21) Appl. No.: 14/234,877

(22) PCT Filed: Jul. 27, 2011
(86) PCT No.: PCT/EP2011/003749

§ 371 Date: Jul. 7, 2014

(51) Int. Cl. G01N 21/87; G06T 7/00; B23K 26/00

(52) U.S. Cl. CPC G01N 21/87; B23K 26/0039; B23K 26/0066; G06T 7/0002
USPC 219/121.76; 219/121.85; 219/121.6; 382/109

(57) ABSTRACT

A system and method are provided for marking valuable articles, particularly precious stones and here in particular cut diamonds (brilliants) and uncut diamonds. An identification marking that is invisible to the naked eye is applied to the article, and data associated with the identification marking is stored for subsequent use in determining the authenticity of the marking. The marking is applied by irradiating a surface of the article with laser light having a wavelength of less than 400 nm and applying ultrasonic oscillations during laser irradiation. A further laser light having a wavelength of more than 500 nm may also be applied to the surface. At least two interference images are generated using at least two different sounding radiation wavelengths for storage, along with an incidence angle of the sounding radiation. The stored data may subsequently be compared to authenticity-checking interference images to determine the authenticity of the identification marking.

### CROSS REFERENCE TO RELATED APPLICATIONS

This application is a continuation of PCT International Application No. PCT/EP2011/003749, filed Jul. 27, 2011, the entire disclosures of which are expressly incorporated by reference herein.

### BACKGROUND AND SUMMARY OF THE INVENTION

The invention relates to a system for marking valuable articles, including precious stones and in particular cut diamonds (brilliants) and uncut diamonds to make subsequent identification possible.

High-quality articles, such as jewelry or other consumer goods, are often marked for the purpose of recognition, and therefore it is possible to trace the origin of the article back to its source. This is particularly important for goods, the quality and value of which can only be determined by especially trained experts. Such recognition signs on goods should be permanent, without reducing the value of the goods.

In the case of precious stones, such as brilliants, there has long been the demand for a safe marking to clearly determine the identity of the stone. Such a marking might assist in discovering and restoring pieces from lost or stolen jewelry. In the case of temporary renting of brilliants, which is not unusual, a permanent marking on the stone for the purpose of recognition would also make it easier to determine that the returned stone is the rented one.

In addition, such detection or indication systems can also serve for indicating the quality or cut quality or polishing of a stone. In principle, the permanent mark or readable identification number (index) on the diamond can also serve quite normally as a sample or trademark, i.e. for identifying the origin. Such a mark can also assist in countering the wide-spread misconception that a diamond or brilliant would basically be an article, the value of which can be determined on the basis of natural features, such as weight, color and transparency. In practice, the quality of a precious stone largely depends on the qualification and the working on the stone by the jeweler, be it the selection of the kind of cutting, the insertion in the setting, the cut and polishing.

As a rule, the marking must be made accompanied by a better resolution and visibility when inspected with a corresponding magnification and/or under corresponding light conditions, wherein the markings may not impair the value and appearance of the diamond or another precious stone.

The method described in U.S. Pat. No. 4,392,476 [1] is known and deals with the production of inscriptions on diamonds by means of a quality-switched neodymium-doped yttrium-aluminum-garnet (YAG) laser having 1.06 bam or frequency doubling. Markings are produced by graphitizing the surface in the focus of the laser. A drawback of this known method is the quality loss of the crystal since graphite particles are formed therein.

A known method for producing one or more individual signs on diamond or precious stone surfaces is Russian patent document no. RU 2215659 [2]. The method produces a plurality of lines on the surface of the stone, which form one or more signs. The marking cannot be recognized by the naked eye; the lines rather become visible under appropriate illumination and magnification conditions as diffraction effects.

The marks do not destroy the clarity of the diamond and can have the shape of one or more alphanumerical signs or similar symbols. The lines as such are formed by focusing an ion bundle. Each incident ion displaces a number of carbon atoms from their spots so as to create interstitial atoms and vacancies in the diamond lattice. The greater the destruction (the lattice defect), the stronger is the inclination towards a replacement of sp3 diamond connections by graphite-like spe connections. These connections can be destroyed by chemical etching to eliminate the imperfect layer. When the dosage and guarantee of a sufficient dosage are limited, the incident ions produce disturbances which convert the diamond into a graphite-like or other non-diamond structure that can be cleaned e.g. with a strong oxidizing agent, such as liquefied saltpeter, at a temperature of about 380-550° C. in several minutes to some hours.

Drawbacks of this method are the comparatively high degree of complexity, since the mark must be chemically etched after its application, and the lack of protection against forgery, since the mark is not unique but only an accumulation of lines having a certain shape and forming alphanumerical signs.

A further method for marking objects, above all precious stones, semi-precious stones and technical diamonds, consists in irradiating the object using laser beams in the U.V. range through a mask placed in the beam path between laser and object until a marking is formed on the surface of the stone, wherein the depth of the marking depends on the duration and intensity of the irradiation (Russian patent document no. RU 2102231 [3]). A drawback is the lack of protection against forgery since the marking is not unique but only an image that corresponds to the transparent cutout in the mask.

A known method for attaching a data mark to a cut diamond pane is Russian patent document no. RU 2161093 [4]. In this method, a data mark invisible to the naked eye is applied to the cut pane of a diamond by irradiating the affected part of the pane surface in the presence of a reagent by means of a radiation having a wavelength of below 400 nm. The reagent reacts with the pane surface and results in the formation of the mark, wherein the flow of radiation may only be so high that no substantial darkening occurs in the mark forming, i.e. the clarity of the diamond is not impaired (below the ablation level of the diamond). The process is carried out in the presence of a reagent (of an oxidizing gas, e.g. air) which reacts with the irradiated part of the pane surface so as to form the mark. The irradiation was made through a mask which consists of a chromium layer applied to a substrate of molten quartz. The transparent areas of the mask were depictions of the letter “alpha”, which had a height of about 1.25 mm. Instead of the above mentioned type, it was also possible to use other masks, and the mask could also show objects other than the letter alpha.

The thus made mark consisted of a number of depictions of the letter alpha and had a height of about 50 pm in the form of a line having a width of 1.5 pm.

A drawback is the lack of protection against forgery since the mark is not unique but is only an image of a letter which corresponds to the transparent cutout in the mask.

Closest to said method is the method for applying a data mark to a cut diamond pane, which is known from U.S. patent document no. 2003038121 [5]. This method exists in two variants. In one variant, the precious stone to be marked is processed, almost as in the above described method, by projecting the image of a photomask accommodated in a laser resonator. In the other variant, the mark is projected onto the surface of the precious stone and, in order to apply the signs and numerals to the surface of the precious stone, the stone is moved in conformity with the predetermined program relative to the laser beam by means of a traveling system.

A drawback is the lack of protection against forgery since the mark is not unique but is only the image of a letter that corresponds to the transparent cutout in a photomask or is created by scanning by means of a laser beam moved relative to the stone.

In order to determine the authenticity of a product, it is not sufficient to merely apply a corresponding marking. For this purpose, means are necessary which enable to determine not only the authenticity of the product but also that of the marking as such. It depends directly on the kind of marking and the character of the identification marks to be applied regarding the means that can be used for this purpose.

In particular the description of Russian patent document no. RU 2205733 (see page 6, lines 10-27 in the left-hand column [6]) proposes to make an image of the rough stone (product) including the marking or to print it on an accompanying certificate. The comparative analysis of the image with the real article enables to verify the conformity between the article and the certificate. The image comprises the entire or part of the marking and identifiable features of the stone, such as the contour of the equatorial area, marking signs, angles, panes, etc. The identity of the stone can be determined by means of the information in the image, such as the marking, the outline of the equatorial area or the like, comparable to the fingerprint of a human. The image on the certificate can be made by means of photography or by means of electron beams. The authenticity of the stone is checked by means of a jeweler's magnifier by comparing the genuine stone with the image provided on the authenticity certificate or the image on the stone as such. Nevertheless, all listed identification features are not unique, they can be reproduced. Therefore, this method cannot serve for determining the identity of the marking described with the below method. The second method described at the stipulated place (RU 220 5733, page 10, lines 2-55 in the left-hand column [7]) proposes to determine the authenticity without a certificate, e.g. only by means of an ordinary jeweler who uses simple means such as a jeweler's magnifier and a phone. The jeweler uses the magnifier for reading out the alphanumerical inscription on the precious stone, which is invisible to the naked eye. The alphanumerical inscription or a part thereof contains information for identifying the precious stone, such as a serial number, which can be inputted into the authenticity recognition system by means of a telephone keypad or the like. The characteristic features of the stone, which were determined at, or approximately at, the time of marking, are then read out of the database. They are usually features, such as cut quality, size, identification and possible defects as well as an image of the stone which shows unique or almost unique properties. For example, it is possible to store the image of the marking and the stone or part thereof, such as markings applied to its girdle or also the outline of its equatorial area. Some or all of these features are then transferred to the jeweler via a speech synthesizer, a telefax message or the like. If a certificate of authenticity was used, the certificate can be reproduced and transferred to the jeweler by telefax so as to confirm the authenticity of the entire information contained in the certificate. The jeweler then compares the transferred data with the properties of the stone and the mark applied thereto. If the stone corresponds to the stored data, the stone is most likely genuine. If the stone fails to correspond to the store data, the stone might be a forgery.

Nevertheless, all listed identification features are not unique, they can be reproduced. Therefore, this method cannot serve for determining the identity of the marking made with the below described method. In addition, there can be difficulties when no jeweler is present at the workplace.

Closest to said method for determining the authenticity of a precious stone marking is the method mentioned in the description of RU 2205733 (see page 12, lines 10-22 in the right-hand column [8]) when a laser irradiation was chosen for the marking. In this connection, it is proposed to store not only the image of the symbols of marking but also the depth of removal.

Nevertheless, both the removal depth and the symbols as such can be reproduced with the corresponding technical equipment, i.e. the identification features are not unique, they can be imitated. Therefore, this method cannot serve for determining the identity of the marking produced by the described method.

Said inventions are directed to ensuring the uniqueness of the marking, their protection against forgery and safe identification during the testing of authenticity.

Said result is obtained by irradiating the corresponding surface of the diamond or brilliant using laser light having a wavelength of less than 400 nm and the surface is simultaneously exposed to the influence of ultrasound and laser light having a wavelength of more than 500 nm when the identification marking invisible to the naked eye is applied.

The result is also obtained by adjusting the radiation energy for the 400 nm laser in such a way that it is below the value where the mark forming impairs the clarity of the diamond or brilliant or where an essential darkening occurs and above the value where graphitization starts.

The result is obtained by using a method for determining the authenticity of the identification marking, said method recording several interference images of the marking at various wavelengths of the sounding rays after the application of the marking During the identification, interference images of the identification markings are again recorded at the same wavelengths and, when the images are identical, it can be assumed that the identification marking is genuine.

The use of two light sources for producing the marking is recommended for the following reasons.

Since a diamond is strongly transparent to energy in a wide wave spectrum, a clear diamond has in particular a low transparence, a low reflectivity and a high degree of absorption at a wavelength of 183 nm, which is almost the limiting frequency of the crystal. Therefore, the energy of the laser in the range of said wavelength is absorbed by a thin superficial layer which heats up strongly and quickly. This thin layer of material at the order of some nanometers to micrometers thus evaporates on the surface under the influence of each pulse and partially graphitizes. An excimer laser can serve as a first source of radiation. Excimer lasers are pulsed gas discharge lasers. A gas mixture (argon and fluorine) is used in these lasers. Excimer lasers are usually used for generating pulses in the range of 193 nanometers (nm) or 0.193 pm to 351 nm, depending on the concretely used noble gas or halide excimer.

Argon-fluorine excimers emit beams having a wavelength of 193 nm. At such a wavelength, the penetration depth of the beam into the clear diamond is minimal. Therefore, only a small amount of material can be removed from the surface of the diamond by evaporation. The other parts of the diamond are heated up to graphitization, i.e. they are converted in an allotropic transformation from a form of elemental carbon, the diamond, into another, the graphite. It is known for a diamond to be converted into graphite when the temperatures are sufficiently high, approximately 900° C., and for the diamond lattice to be fully destroyed. However, the material can be fully or partially converted into graphite before this destruction occurs and still retain the strength and hardness of the diamond lattice.

It is assumed that a diamond can undergo such a conversion both in the crystal lattice and on the surface thereof since darkened or graphitized zones have been found which could not be removed as usual from the diamond lattice by etching using acid. A fully visible identification marking is thus formed, the presence of which reduces the quality of the crystal and can easily be discovered. YAG lasers (with yttrium-aluminum-garnet) or Nd:YAG lasers (with neodymium-doped yttrium-aluminum-garnet) are sometimes used in laser marking systems. They operate at a wavelength of 1.06 pm or with frequency doubling. For example, the radiation emitted by the laser and having a wavelength of 1.06 or 0.532 pm is incident upon the diamond. Since diamonds are basically transparent for said wavelengths, energy-absorbing covers on the surface to be marked, such as carbon soot, are used for such marking methods for diamonds, thus complicating the method.

If a laser having a wavelength of less than 400 nm is used simultaneously with or followed by a laser having a wavelength of more than 500 nm, the pulses of the excimer laser produce in the irradiated spot (region) a graphitization focus which comprises local regions with material in various phase states while the pulsed lasers emitting at 1.06 pm or 0.532 create the electric field strength necessary for the optical breakdown. Because of the influence of the strong electromagnetic fields on the region of graphitization, local spark discharges are created, as a result of which material is destroyed and additional micro and nano defects are formed accompanied by crack formation. The result is an identification mark protected against copying, reproduction and forgery since a spark discharge is created by the influence of the laser which produces the high electric field strength, said spark discharge effecting local destructions of material, the shape of which is determined by the electrical and mechanical conditions prevailing in the respective field.

The radiation energy for the 400 nm laser must be adjusted in such a way that it is below the value where the mark forming impairs the clarity of the diamond or brilliant or where a substantial darkening occurs and above the value where graphitization starts, and therefore only the focus which is necessary for the further formation of micro and nano cracks and for the removal by the lasers operating at 1.06 or 0.532 pm is created in the irradiated spot. This setting for the laser operating at less than 400 nm can readily be derived from what we know. What is known is the dependence of the damage of the diamond surface on the energy density of the beam, which is a step function. Below the lower limiting value, no damage occurs, the upper limiting value is exceeded and the damage no longer increases even if the energy density is further increased. Therefore, the desired result can be obtained by controlling the output energy of the excimer laser.

The use of both optical and ultrasonic sources for producing the marking is recommended for the following reasons. When the diamond is heated by laser radiation, its mechanical crack resistance is reduced. The ultrasound effects the development of the nano and micro cracks in the diamond interior. The nano and micro cracks are developed under the conditions of the non-repeatable distribution of the atoms, admixtures and internal stresses in the diamond. As a result, the mark becomes unique and cannot be reproduced.

The storage of several interference images of the identification marking at various wavelengths of the sounding rays after the application of the marking makes it possible in the proposed method to determine the authenticity of the marking, the spectral properties of the mark and the reflection coefficient thereof which depends on the properties of the initial material, the degree of graphitization and on the three-dimensional dimensions of the mark. Even if the others remain untouched, the change in each of these parameters changes the spectral properties and thus changes the reflection coefficient of a predetermined region at a certain wavelength. These properties depend on the original distribution of the atoms in the piece, the development of the graphitization range under the influence of the laser and the expansion of the region of removal (material evaporation).

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic view of the practical realization of a method for marking by two lasers and an ultrasonic source in accordance with an embodiment of the present invention.

FIG. 2 is a schematic view of a method for determining the authenticity of the identification marking in accordance with an embodiment of the present invention.

### DETAILED DESCRIPTION OF THE INVENTION

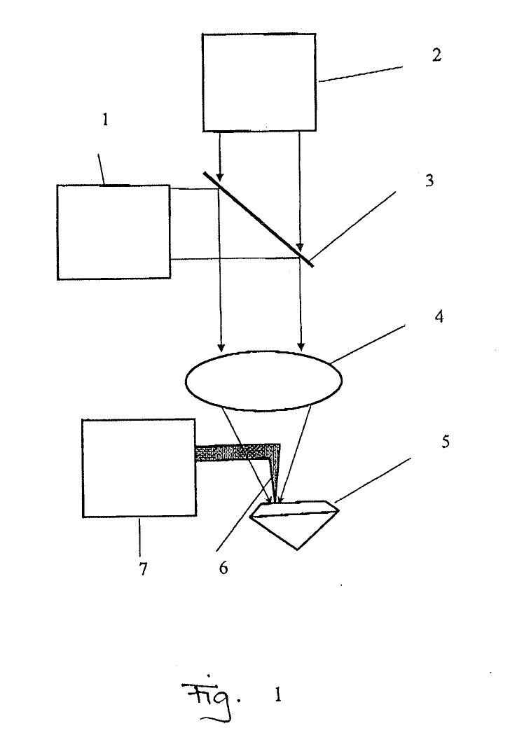

A first example of a method for applying the identification marking invisible to the naked eye on the surface of the diamond or brilliant can be realized in a variant with a device, the schematic view of which is found in FIG. 1. The writing device consists of laser 1 which emits waves shorter than 400 nm, and laser 2 which operates with waves above 500 nm. The emissions of the lasers are combined into a bundle by the spectral selective, i.e. partially transparent, mirror 3 and sent to focusing lens 4. The workpiece 5 to be processed is positioned in the focus of the lens. The core 6 consisting of a hard material and provided with a tip is connected to the workpiece. The tip as such is connected to the ultrasonic generator 7 operating with electric oscillations. All components belonging to the device are known components/assemblies. In order to produce the identification marking (mark), the focusing radiation of lasers 1 and 2 increases the temperature in the region of the pane surface onto which it is incident and where it produces the spark-over, which results in the formation of three-dimensional micro and nano cracks (nano structures). The dimensions thereof depend on the arrangement of the atoms in the initial material, the admixtures, the local internal stresses and the spatial properties of the laser beam bundle. At the same time, the region processed by the laser beams is also treated with ultrasound through the core. The operating parameters of the device and thus also the reaction of the method (energy density of the laser emissions, duration of irradiation, duty cycle, frequency, output, amplitude of the ultrasonic oscillations, etc.) can be determined by way of experiment. In terms of the invention, the conditions indicated in the formula of the invention have to be complied with here when the parameters are selected. In particular, the radiation energy for the 400 nm laser has to be adjusted in such a way that it is below the value where the mark forming impairs the clarity of the diamond or brilliant and/or where an essential darkening occurs and above the value where graphitization starts so as to form the focus only in the irradiated spot which is necessary for the further formation of micro and nano cracks and for the removal by the lasers operating at 106 or 0.532 pm.

As a result of the operation of the device accompanied by a simultaneous or alternating laser and ultrasonic treatment of the region to be processed, unique micro and nano defects are created for the production of the mark.

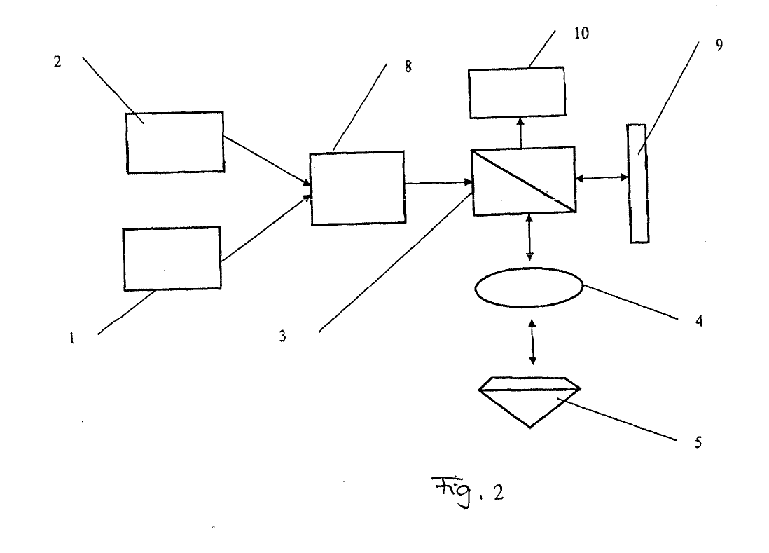

A second example of the method for determining the authenticity of the identification marking invisible to the naked eye on the surface of a diamond or brilliant can be realized with the device and the schematic presentation thereof is shown in FIG. 2.

The device consists of an interference microscope in which the interference images are measured at various wavelengths which are generated by radiation sources operating at wavelengths Ä1 and Ä2. The microscope comprises individual assemblies which also belong to the marking device and assemblies which are only used in the here described microscope. The equipment which belongs to the microscope comprises the radiation source 1 (wavelength KI), the radiation source 2 (wavelength Ä2), the semitransparent mirror 3, the focusing lens (objective) 4, the diamond (brilliant) 5 to be checked, the emission adder 8 having various wavelengths (frequency multiplexer), the auxiliary mirror 9 and the optical measuring device 10 based on a photosensitive matrix. The measuring device measures and registers the spatial distribution of the optical radiation power of the interference image which is formed by the superposition of the rays reflected by the object 5 to be tested and by the auxiliary mirror 9.

All components belonging to the device are known components/assemblies. The method is to be implemented as described below.

In the measurement, the radiation sources 1 and 2 are switched on in succession. The emission of the two sources operating at various wavelengths is sent through the emission adder 8 and directed at the split mirror 3. The rays are directed from the split mirror at the auxiliary mirror 9 and through the objective 4 further to the object (diamond) 5 which is to be tested and has the micro mark. The radiation reflected by the micro mark on the object 5 to be tested is sent back through the objective 4 to the optical measuring device 10 where an interference with the radiation reflected by the auxiliary mirror 9 occurs. As a result, the interference image is formed on the surface of the measuring device 10. When the radiation sources 1 and 2, which operate at the different wavelengths Ä1 and Ä2, are then switched on, various interference images are obtained which are measured and recorded by the optical measuring device 10 that is based on a light-sensitive matrix. The resulting images, which are stored as hardcopy or on a data carrier, can be enclosed to the certificate of the brilliant (diamond). In order to check the authenticity of the brilliant, the stone is subjected to the above described procedures and the thus obtained images are compared with the original images. If these images are identical, it has to be assumed that the identification marking is genuine, if not, it is a forgery.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-6. (canceled)

7. A method for applying an identification marking which is invisible to the naked eye to a diamond or brilliant, comprising the steps of:
exposing a region of a surface of the diamond or brilliant to a laser light having a wavelength of more than 500 nm;
ultrasonically oscillating the region during laser light exposure to generate at least two interference images of the identification marking at different wavelengths of a sounding radiation; and
storing the at least two interference images with data on the exposed region and an angle of incidence of the sounding radiation.

8. The method according to claim 7, Further comprising the step of:
exposing the region of the surface to a further laser light operating at a wavelength of less than 400 nm and at a radiation energy thereof adjusted so as to be:
below a value of radiation energy where the identification marking forming at least one of impairs the clarity of the diamond or brilliant and a substantial darkening occurs, and
above a value of radiation energy where graphitization starts.

9. The method according to claim 8, wherein the radiations and the ultrasonic treatment are applied at least one of simultaneously, in sequence and intermittently.

10. The method according to claim 7, further comprising the steps of:
determining authenticity of the identification marking with the stored data, wherein the authenticity is determined by
generating at least two authenticity-check interference images of the identification marking by applying the sounding radiation to the region during application of the different wavelengths; and
comparing the at least two authenticity-check interference images with the stored interference images to determine whether the interference images match.

11. A method for determining authenticity of an identification marking which is invisible to the naked eye on a diamond or brilliant, comprising the steps of:
generating at least two authenticity-check interference images of the identification marking at different wavelengths of a sounding radiation to a region of a surface of the diamond or brilliant during exposure of the region to a laser light wavelength used to apply the identification marking to the diamond or brilliant, wherein , the different wavelengths of the sounding radiation correspond to wavelengths used during application of the identification marking;
retrieving stored data in the form of at least two interference images generated at the application of the identification marking, including an angle of incidence of the sounding radiation; and
comparing the at least two authenticity-check interference images with the stored interference images to determine whether the interference images match.

12. A system for applying an identification marking which is invisible to the naked eye to a diamond or brilliant, comprising:
at least one laser light source having a wavelength of more than 500 nm, the laser light source being configured to expose a region of a surface of the diamond or brilliant to laser light;
an ultrasonic oscillation device, the ultrasonic device being configured to oscillate the region during laser light exposure to generate at least two interference images of the identification marking at different wavelengths of a sounding radiation; and
identification marking storage, the storage being configured to store the at least two interference images with data on the exposed region and an angle of incidence of the sounding radiation.

13. The system according to claim 12, further comprising:
a further laser light source operating at a wavelength of less than 400 nm, the further laser light source being configured to expose the region to laser light at a wavelength of less than 400 nm and at a radiation energy thereof adjusted so as to be:
below a value of radiation energy where the identification marking forming at least one of impairs the clarity of the diamond or brilliant and a substantial darkening occurs, and
above a value of radiation energy where graphitization starts.

14. The system according to claim 13, wherein the radiations and the ultrasonic treatment are applied at least one of simultaneously, in sequence and intermittently.
